(19) United States
(12) Patent Application Publication
(10) Pub. No.: US 2013/0232671 A1
(43) Pub. Date: Sep. 12, 2013

(54) Thread Based On High-Tenacity Meta-Aramid And Textile Using This Thread

(71) Applicants: Benoit Bouret, Lyon (FR); Denis Coulaux, Caluire (FR)

(72) Inventors: Benoit Bouret, Lyon (FR); Denis Coulaux, Caluire (FR)

(21) Appl. No.: 13/481,093

(22) Filed: May 25, 2012

(30) Foreign Application Priority Data
Mar. 7, 2012 (FR) 12 52064

(51) Int. Cl. D02G 3/02; A62B 17/00; D04B 13/00; D04B 21/10; D03D 15/00; D04B 21/00

(52) U.S. Cl. 2/455; 428/401; 442/189; 442/312; 442/1

(57) ABSTRACT

A thread essentially composed of poly(meta-phenylene isophthalamide), that is to say meta-aramid. It consists of a yarn of fibers, the distribution of the length of said fibers being between 40 and 200 millimeters, and the minimum quantity of fibers in cross section being 40.

### CROSS-REFERENCE TO RELATED APPLICATIONS

The present application claims priority of French Patent Application No. 1252064 filed on Mar. 7, 2012, the content of which is incorporated herein by reference.

### FIELD OF THE INVENTION

The present invention lies in the field of textiles having properties of both resistance to heat and flame and resistance to abrasion. The purpose of such textiles is to be used in the context of the manufacture of garments for protection against flame and electric arc and in general terms all sources of heat, and therefore in garments more particularly intended for firefighters, military personnel or industry personnel exposed to risks of exposure to flame.

### BACKGROUND OF THE INVENTION

The development and refinement of garments able to provide protection for the user against the effects of heat have been a priority for the relevant manufacturers for a long time. This need is particularly pressing in the case of firefighters and military personnel.

Among the various solutions proposed at the present time, the use of so-called thermostable, that is to say fire-resistant, fibers is known. Such fibers consist in particular of aramids, in particular meta-aramid, better known by the registered trademark Nomex®, or para-aramid, better known by the registered trademark Kevlar®.

Whether it is a case of meta- or para-aramid, these synthetic fibers have high performance in particular in terms of thermostability, but also in terms of mechanical strength.

The synthetic fibers classified in the family of high-performance fibers actually provide the best compromise between mechanical strength and thermostability when it is a case of producing lightweight non-fire fabrics compared with other natural or synthetic materials.

However, para-aramid has the drawback of significantly impairing the comfort of the user because of its relative rigidity. In addition, this fiber has a weak tinctorial affinity during dyeing operations, as well as weak resistance to ultraviolet, significantly reducing the applications thereof. In fact, this fiber is mainly used in the field of ballistics or for clearly determined industrial applications.

Meta-aramid fiber is also used for industrial applications such as filtration, rubber reinforcement, etc. For individual protection, it is very rarely used on its own. In order to optimize the mechanical strength and flame-resistance thereof, it is very often associated with para-aramid in concentrations of between 5% and 85% by weight of the thread.

Such a blend is, for example, marketed by the company Dupont de Nemours under the reference Nomex type 455, and consists of 95% meta-aramid and 5% para-aramid.

Though this product has enjoyed a certain degree of commercial success, it does nevertheless have a certain number of drawbacks. Among these, there is first of all the drawback relating to the states of conversion and preparation of the fibers, in particular during spinning, weaving, dyeing and maintenance of the textile.

In addition, experience shows that the abrasion resistance of such a product is relatively low and this type of product also has a tendency to pilling, that is to say the formation of small fluffy balls on its surface, mainly due to rubbing.

Thus, in order to produce a well-made fabric from a blend consisting of 95% meta-aramid and 5% para-aramid meeting criteria of acceptable abrasion and pilling resistance, it is essential to have a sufficiently tight fabric density, the aim being to limit movement of the fibers with respect to one another and consequently the effect of shearing of the fibers when the fabric is rubbed. This requirement significantly degrades the permeability to air of the fabrics and de facto comfort in wearing.

In other words, at the present time there are no available textiles which combine all the properties of thermostability, mechanical strength, or even comfort, or price, and a compromise must necessarily be envisaged to the detriment of one or even two of these three sought-after characteristics.

The invention therefore aims to obtain a textile based on meta-aramid, wherein each operation of conversion of the fiber to the dyed fabric has been optimized so as to obtain a thread of superior quality, able to optimize the mechanical characteristics, especially breaking strength and resistance to tear and abrasion, with a view to the manufacture of individual-protection textiles and reinforcement elements for certain applications in the industrial field.

### SUMMARY OF THE INVENTION

To this end, the invention relates first of all to a thread essentially composed of poly(meta-phenylene isophthalamide), that is to say meta-aramid, consisting of a yarn of fibers, the distribution of the length of said fibers being between 40 and 200 millimeters, and wherein the minimum quantity of fibers in cross section is 40.

By the adverb “essentially”, the invention intends to signify that a very large concentration of meta-aramid is used to the exclusion of para-aramid.

In fact, the invention can also provide, in the context of the production of the thread of the invention, either a thread consisting of 100% meta-aramid or, in variants described in more detail below, the addition of antistatic fibers composed of a conductive core based on carbon fiber and covered with a matrix based on polyamide 6 or polyamide 66. The effect of controlling electrostatic charges is obtained by transfer and diffusion of the charge and by corona discharge. Such a fiber is for example marketed under the trade name Beltron®, and manufactured by the company KB SEIREN. This fiber confers a definitive antistatic character on the textile using this thread, and in particular on the fabric, so as to comply with EN 1149-3. The proportion of these fibers is typically between 1% and 3% by weight.

The invention also relates to textiles resulting from the use of such a thread, in particular woven fabric, with the insertion of the thread of the invention in the warp and weft. The thread can also be weft- or warp-knit.

It can be used in the production of reinforcement for plastic, rubber, polymer, fluoropolymer, nitrile, or butyl, or even for supporting breathable waterproof membranes.

### DETAILED DESCRIPTION OF THE INVENTION

The thread according to the invention therefore consists essentially of meta-aramid.

According to the invention the base fibers were obtained from a multifilament precursor of meta-aramid, having a tenacity of 36 cN/tex.

The base fiber is obtained by a preparation method known by the term stretch-breaking. This method consists of breaking a precursor cable of continuous filaments by stretching and controlled breaking between cylinders rotating at different speeds. The cable actually passes between two series of rollers where the speed of the output rollers is higher than the speed of the input rollers. This method arranges and aligns the crystalline areas of the polymer until the most fragile chemical bonds rupture.

In this way a tow is obtained with fiber lengths having a regular distribution between 40 and 200 millimeters, wherein each unit fiber contains a crystalline orientation optimized in the direction of the length thereof.

The (Gaussian) distribution of the length of the fibers is much wider than the system of fibers obtained by cutting by guillotine or cutter, which confers superior mechanical properties on the thread resulting therefrom.

The fiber spinning system that results therefrom is conventional, namely the stretched-broken fiber tow is refined and spun on a long fiber ring spinning system.

The thread resulting from this spinning is extremely homogeneous and regular, affording better resistance to pilling and abrasion for the textile using this thread.

In addition, a thread is obtained wherein the minimum quantity of fibers over the cross section is typically 40 to 50, thus making it possible to obtain a very fine unit yarn of fibers, able to optimize the comfort of the garment produced from such a thread.

In fact, a thread is obtained wherein the size is typically between 85 and 220 dtex, and having a tenacity of 30 cN/tex when the thread is composed of 100% meta-aramid.

Obviously, this value of the tenacity also depends on the tenacity of the starting precursor. In this case, this tenacity was measured when that of the starting precursor was 36 cN/tex. In doing this, it can be observed that a thread is obtained wherein the tenacity exceeds the original tenacity by more than 80%.

It is necessary to compare this feature with that of a thread resulting from spinning carried out using short fibers, that is to say wherein the original fibers are obtained by cutting by guillotine or cutter. The measurements of tenacity carried out for a thread thus obtained, also based on meta-aramid, show that a value of only 20 cN/tex is observed.

Advantageously, it is possible to add to the meta-aramid fibers, that is to say before spinning and production of the thread of the invention, fibers conferring antistatic properties, such as in particular fibers of carbon/Beltron® type 931 polyamide or other fiber conferring a definitive antistatic character on the fabric. The proportion of these antistatic fibers is typically between 1% and 3% by weight, in order to comply with EN 1149-3.

For reasons of comfort, it is also possible to envisage integrating other fibers in the production of the thread of the invention, and in particular viscose, wool, or silk, typically at the rate of 11% to 13% by weight.

The thread in question is converted in the form of so-called warp and weft fabric. In fact, threads are intersected perpendicularly in a repetitive binding mode over the width and length of the fabric. In this case the fabric has been defined to meet the requirements of manufacture for protective garments, such as bomber jackets, flying suits, or the external layer of a firefighter jacket.

The thread envisaged is a 110 dtex Nomex® twofold thread with a breaking strength of 680 cN measured according to ISO 2062 8-2. The fabric is a 2×2 twill with a weight of 160 grams per square meter.

A system for controlling the tensions of the threads when the reels are paid out and when the thread is warped is established in order to limit phenomena of tension and overtension. A constant tension of 0.20 N is applied to each thread.

The objective is to obtain a perfect identical tension between each thread constituting the warp of the fabric as well as low thread hairiness before weaving.

A check on the breaking strength of the thread is carried out before weaving with an average value of 678 cN measured according to ISO 2062 8-2 before weaving compared with 680 cN on the original thread.

The weaving is carried out on machines, the components of which are modified so as to reduce the phenomena of friction and erosion of the thread. A mechanical strength test after weaving shows that the thread has kept the mechanical strength of 678 cN.

After weaving, the fabric is finished according to the conventional method of dyeing meta-aramids with continuous prewashing in order to eliminate oils and impurities, then dyed by jet or autoclave. The fabric is then dried and stabilized on a stenter. Post-washing is then carried out in order to eliminate all traces of excess of dyes or solvents. After checking the strength of the thread on the finished fabric, the value of 675 cN is very close to the original value of 680 cN measured according to ISO 2062 8-2.

### EXAMPLE EMBODIMENT

### Example 1

Invention—Fabric manufactured from the thread of said invention with a tenacity of 30 cN/Tex. The thread was placed in the direction of the warp with a density of 32 threads/cm. The construction is a 2×2 twill. The final weight is 160 g/m².

### Example 2

A fabric is produced according to the same weave and the same thread density in warp and weft, using a fiber produced in Nomex® type 455 meta-aramid with the same density.

The following table sets out the characteristics obtained

| | | | Warp | Weft | Warp tear | Weft tear | | |
|---|---|---|---|---|---|---|---|---|
| | | Weight | resistance | resistance | strength | strength | Abrasion | |
| | | EN | EN ISO | EN ISO | EN ISO | EN ISO | ISO | Pilling |
| Reference | Material | 12127 | 13934-1 | 13934-1 | 13937-2 | 13937-2 | 12947-2 | EN 12945-2 |
| Example 1 | 100% | 160 g/m² | 120 | 120 | 8.5 | 8.7 | 75000 | 5 |
| | Meta- | | | | | | | |
| | aramid | | | | | | | |
| Example 2 | 93% | 160 g/m² | 100 | 100 | 3.7 | 4 | 32000 | 3 |
| | Meta- | | | | | | | |
| | aramid | | | | | | | |

It thus stems from these comparative examples that, first of all, a fabric is obtained with the thread of the invention having a mechanical strength superior to that of example 2 by more than 20%, and in addition a 50% higher tear strength.

A resistance to abrasion that is twice as high with 32,000 cycles at a pressure of 12 kPa is also noted, that is to say in accordance with the tests carried out in conformity with ISO 12947-2.

1. Thread essentially composed of poly(meta-phenylene isophthalamide), that is to say meta-aramid, consisting of a yarn of fibers, the distribution of the length of said fibers being between 40 and 200 millimeters, and the minimum quantity of fibers in cross section being 40.

2. Thread according to claim 1, wherein the precursor of the fibers that make it up is natural in color or pigmented.

3. Thread according to claim 1, wherein fibers with an antistatic property form part of said thread, to the extent of 1% to 3% by weight.

4. Thread according to claim 2, wherein fibers with an antistatic property form part of said thread, to the extent of 1% to 3% by weight.

5. Thread according to claim 1, wherein viscose, wool or silk fibers form part of said thread, to the extent of 11% to 13% by weight.

6. Fabric obtained by means of a thread according to claim 1, inserted in the warp and weft.

7. Knitted fabric obtained by means of a thread according to claim 1, produced on a warp or Raschel or circular knitting machine.

8. Garment protecting against heat, and in particular against fire, produced from a fabric or knitted fabric according to claim 6.

9. Garment protecting against heat, and in particular against fire, produced from a fabric or knitted fabric according to claim 7.

10. An element for reinforcing plastics material, rubber, polymer, fluoropolymer, nitrile, or butyl, produced from a fabric according to claim 6.
